(19) United States
(12) Patent Application Publication
(10) Pub. No.: US 2024/0089591 A1
(43) Pub. Date: Mar. 14, 2024

(54) NON-TRANSITORY COMPUTER-READABLE STORAGE MEDIUM STORING DISPLAY CONTENT NOTIFICATION PROGRAM, DISPLAY CONTENT NOTIFICATION DEVICE, DISPLAY CONTENT NOTIFICATION METHOD

(71) Applicant: SEIKO EPSON CORPORATION, Tokyo (JP)

(72) Inventor: Tomoyuki HIRANO, Azumino (JP)

(21) Appl. No.: 18/462,452

(22) Filed: Sep. 7, 2023

(30) Foreign Application Priority Data
Sep. 9, 2022 (JP) 2022-143533

(51) Int. Cl. H04N 23/60; G06T 7/70; G06V 20/62

(52) U.S. Cl. CPC H04N 23/64; G06T 7/70; G06V 20/62

(57) ABSTRACT

A computer provided with a camera analyzes an image obtained by imaging a target instrument by the camera, identifies a model of the target instrument, translates a display content of the target instrument, which is included in the image, based on a translation rule corresponding to the identified model, and notifies a user of a translation result.

The present application is based on, and claims priority from JP Application Serial Number 2022-143533, filed Sep. 9, 2022, the disclosure of which is hereby incorporated by reference herein in its entirety.

### BACKGROUND

### 1. Technical Field

The present disclosure relates to a non-transitory computer-readable storage medium storing a display content notification program, a display content notification device, and a display content notification method.

### 2. Related Art

Heretofore, with regard to an electronic instrument provided with a plurality of LEDs which turn on and blink in order to provide some information, a technique has been known, which analyzes an image obtained by capturing an LED portion by a smart phone and the like, and expresses the analyzed image by a human-readable message (for example, see JP-A-2016-177763).

However, in the related art, a model of the electronic instrument is not identified, and accordingly, appropriate guidance according to the model cannot be made.

### SUMMARY

A display content notification program stored in a non-transitory computer-readable storage medium, the display content notification program serving for solving the above-described problem, is a program to control a computer provided with a camera, the program causing the computer to execute: an analysis function to analyze an image obtained by imaging a target instrument by the camera, and to identify a model of the target instrument; a translation function to identify a translation rule, which corresponds to the identified model, from a plurality of translation rules, and to translate a display content of the target instrument, which is included in the image, based on the identifies translation rule; and a notification function to notify a user of a translation result.

A display content notification device for solving the above-described problem includes: a camera that images a target instrument; and a notification unit that notifies a user of a translation result of translating an image imaged by the camera, in which the translation result is a result of translation performed by using a translation rule corresponding to a model of the target instrument, which is identified by analysis of the image.

A display content notification method for solving the above-described problem is a display content notification method is a display content notification method including: causing a camera to image a target instrument; and notifying a user of a translation result of translating a display content included in the imaged image, in which the translation result is a result of translation performed by using a translation rule corresponding to a model of the target instrument, which is identified by analysis of the imaged image.

### BRIEF DESCRIPTION OF THE DRAWINGS

FIG. 1 is a block diagram of a display content notification device.

FIG. 2 is a diagram illustrating an example of an operation panel of a printer.

FIG. 3 is a diagram illustrating an example of the operation panel of the printer.

FIG. 4 is a diagram illustrating an example of an auxiliary line.

FIG. 5 is a diagram illustrating a notification example of a translation result.

FIG. 6 is a flowchart of display content notification processing.

### DESCRIPTION OF EMBODIMENTS

Herein, a description will be given of embodiments of the present disclosure according to the following order.
1. Configuration of display content notification device
2. Display content notification processing
3. Other embodiments

### 1. Configuration of Display Content Notification Device

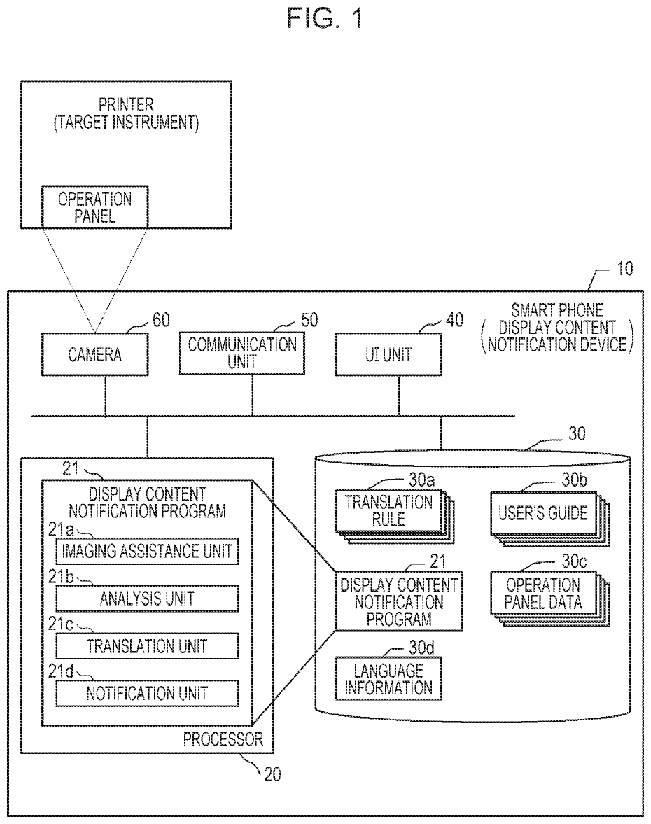

FIG. 1 is a block diagram illustrating a configuration of a smart phone 10 as a display content notification device according to an embodiment of the present disclosure. The smart phone 10 includes a processor 20, a storage medium 30, a UI unit 40, a communication unit 50, and a camera 60.

The processor 20 controls the smart phone 10 by executing a variety of programs stored in a ROM, the storage medium 30 and the like. The processor 20 may be composed of a single chip, or may be composed of a plurality of chips. Moreover, in this embodiment, the processor 20 is assumed to be a CPU, but may be composed of an ASIC or the like, or may be composed of the CPU and the ASIC. The communication unit 50 is provided with a circuit for use in communication according to a variety of wired or wireless communication protocols, the communication being made with an external instrument.

The camera 60 is provided with a lens, an area image sensor and an image processing circuit, and images a subject to generate an image. When the camera 60 is activated, the camera 60 performs imaging at predetermined intervals, the processor 20 acquires the images output by the camera 60, and controls the UI unit 40 to continuously display the acquired images as a live view video on a display. When an instruction to image a still image is made by a user, a still image file converted into a predetermined format of a still image is generated. When an instruction to image a moving picture is made by the user, a video file converted into a predetermined format of a video is generated.

The UI unit 40 includes a touch panel-type display. The display displays a variety of information such as letters and images in accordance with a control of the processor 20. The live view video and the imaged still image and moving picture are displayed on the display, and the user can visually recognize these images by the display. Moreover, the user performs touch operations for varieties of icons and buttons, which are displayed on the display, and can thereby input, to the smart phone 10, a variety of instructions to activate an application program installed in the smart phone 10, to activate the camera 60, to image a moving picture and a still image, and so on.

The storage medium 30 stores a variety of programs including a display content notification program 21 to be described later, and information on a translation rule 30a, a user's guide 30b, operation panel data 30c and the like. Details of these pieces of information are described later. Moreover, the storage medium 30 stores language information 30d indicating a language to be used by the user on the smart phone 10, and in an operating system of the smart phone 10, the language indicated by the language information 30d is set as a language to be used by the user.

The display content notification program 21 is one of application programs executable by the processor 20. In this embodiment, the display content notification program 21 is a program that causes the processor 20 to achieve a function to acquire a moving picture obtained by imaging a display content of an electronic instrument for a certain period by the camera 60, to identify a model of the electronic instrument and the display content of the electronic instrument based on the imaged video, and to notify the user of the display content. In this embodiment, it is assumed that the electronic instrument (target instrument) taken as a translation target of the display content is a printer.

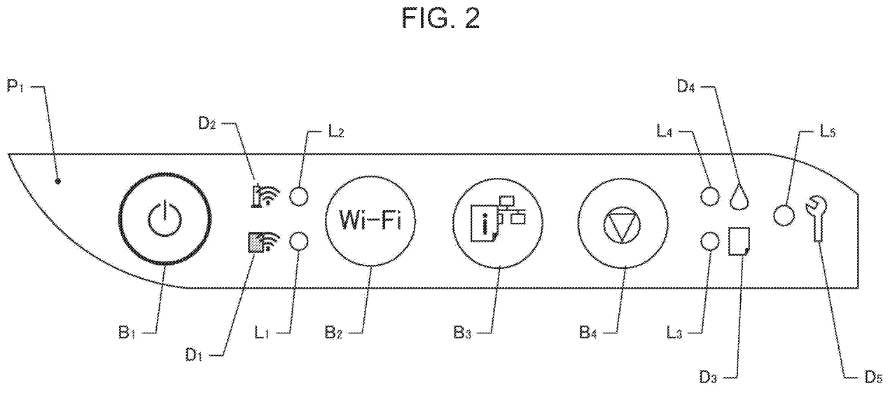

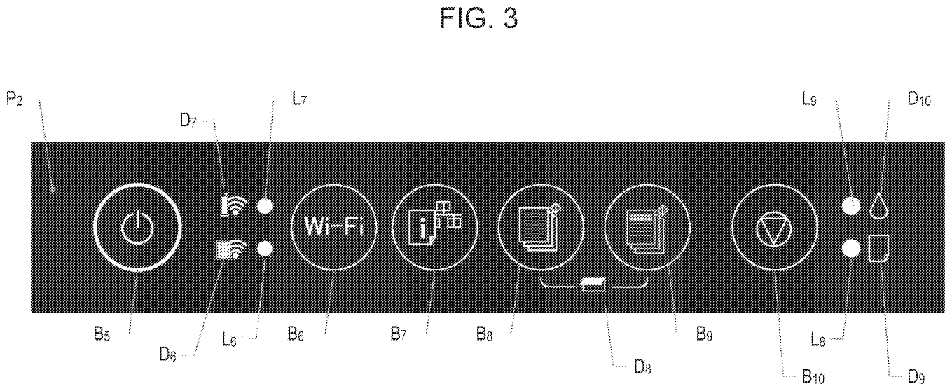

For example, as illustrated in FIG. 2 and FIG. 3, the printer as a target instrument is provided with operation panels which vary depending on such models. The operation panels in the examples illustrated in FIG. 2 and FIG. 3 are provided with buttons and LEDs, and are not provided with liquid crystal panels. In the case of notifying the user of some messages, the printer provided with the operation panel illustrated in FIG. 2 or FIG. 3 turns on or blinks the LEDs. The electronic instrument is configured to turn on or blink (or turn off) a plurality of the LEDs in a predetermined light emission pattern, and to thereby express a message indicated by this light emission pattern.

For example, in the example of FIG. 2, reference symbols L₁ to L₅ denote units (which are called LED units) which emit light by LEDs individually corresponding thereto, and reference symbols B₁ to B₄ denote buttons. Note that a contour of the button B₁ emits light by the LED. In both of a turning-on state and a turning-off state, the LED units are different in color from an exterior surface P₁ of the operation panel. Reference symbols Di to Ds denote patterns formed on the exterior surface P₁ of the operation panel.

Moreover, for example, in the example of FIG. 3, reference symbols L₆ to L₉ individually denote LED units, and reference symbols B₅ to B₁₀ denote buttons. Note that the button B₅ emits light by an LED. In both of a turning-on state and a turning-off state, the LED units are different in color from an exterior surface P₂ of an operation panel. Reference symbols D₆ to D₁₀ denote patterns formed on the exterior surface P₂ of the operation panel. The arrangement, number and type of the buttons and the LEDs are different between the example illustrated in FIG. 2 and the example illustrated in FIG. 3.

The user can investigate the messages, which are indicated by the light emission patterns of these LED units, with reference to the user's guide corresponding to the model of the printer; however, work therefor can be a burden for the user for the following reasons. The user's guide can be present as paper media or electronic media. The user's guide as paper media may not sometimes be close at hand due to disposal, loss and the like. Moreover, though it is also possible to browse the user's guide as electronic media, which is provided by a printer manufacturer, for example, through the Internet, there occur time and effort to search for a model number of the target instrument and to identify a described space corresponding to the light emission pattern of the LED units. Moreover, in both of the paper media and the electronic media, it is necessary for the user to determine the light emission pattern of the LED units, and this can be a burden of the user. Further, in a user with color blindness, it is sometimes difficult to determine the light emission pattern of the LED units.

Accordingly, in this embodiment, the user is caused to image the moving picture of the operation panel of the printer by using the camera 60 of the smart phone 10, and the smart phone 10 analyzes the live view video, and thereby identifies the model of the printer. Then, the smart phone 10 determines the light emission pattern of the LED units, translates the message, which is indicated by the light emission pattern, with reference to the translation rule 30a corresponding to the model of the printer, displays a translation result on the display of the UI unit 40 of the smart phone 10, and thereby notifies the user of the translation result. As a result, the user himself/herself does not need to identify the user's guide corresponding to the model of the target instrument, to determine the light emission pattern of the target instrument, or to find, from the user's guide, the space where the light emission pattern is described, so that the burden of the user can be reduced.

In this embodiment, each of such printers as target instruments is classified into any of model groups. The model group is a group of models in which the types and numbers of the buttons on the operation panel, the numbers of the LED units, the arrangements of the buttons and the LED units are common to one another, and such messages indicated by the light emission patterns of the LED units are common to one another. The translation rule 30a is prepared for each of the model groups. The translation rule 30a is information in which the light emission pattern and the message indicated by this light emission pattern are associated with each other. More specifically, in this embodiment, the translation rule 30a is information indicating a correspondence relationship between the light emission pattern and the space where the message indicated by this light emission pattern is described in the user's guide 30b.

The user's guide 30b is an operation manual of the instrument corresponding to the model group, and is described in a plurality of languages. In the translation rule 30a, described are correspondence relationships of the message indicated by the light emission pattern with spaces where the respective languages are described in the user's guide 30b. Note that, with regard to the user's guide 30b, the model group and language thereof are designated by the user, for example, at the time when the display content notification program 21 is installed, is downloaded from a Web site of the printer manufacturer, and is stored in the storage medium 30. Alternatively, adopted may be such a configuration in which the user's guide corresponding to the model group and the language is downloaded from the relevant Web site after the model group of the target instrument is identified and the language to be used by the user is identified as described later.

The display content notification program 21 includes an imaging assistance unit 21a, an analysis unit 21b, a translation unit 21c, and a notification unit 21d. By a function of the imaging assistance unit 21a, the processor 20 causes the camera 60 to image a moving picture, and causes the imaged video to be displayed as a live view video on the display of the UI unit 40 of the smart phone 10. Moreover, by an imaging assistance function of the imaging assistance unit 21a, the processor 20 causes display of an auxiliary line that is superimposed on the live view video and indicates a position into which the target instrument is captured.

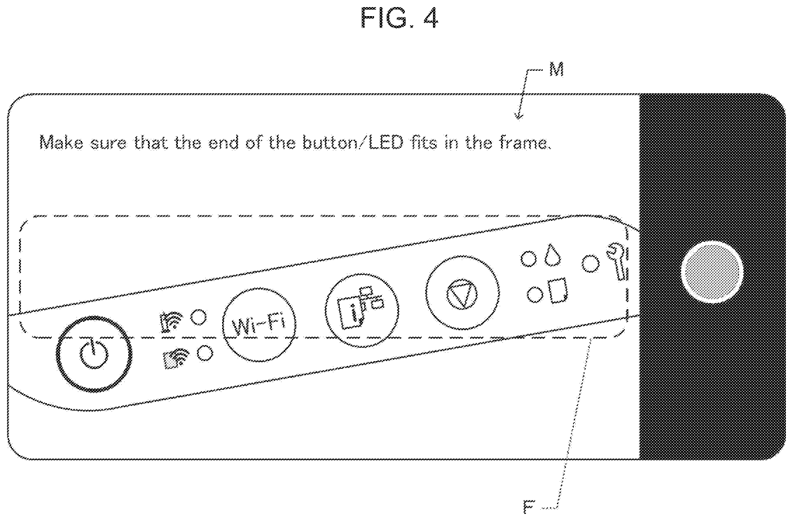

FIG. 4 illustrates an example of the auxiliary line (a frame F) displayed on the display of the smart phone 10. In this embodiment, the processor 20 causes the display to display the live view video, and in addition, causes the display to display the frame F surrounded by the auxiliary line that is a broken line. Moreover, the processor 20 causes, in a superimposed manner on the live view video, display of a message M that prompts the adjustment of a distance between the target instrument and the smart phone 10 and an attitude of the smart phone 10 with respect to the target instrument so that the end of the button and LED of the target instrument fits in the frame F. Therefore, the user can adjust a positional relationship between the smart phone 10 and the target instrument so that the operation panel of the target instrument is captured in an area illustrated in the frame F. As a result, each of the frame images of the live view video can increase a possibility to become an image in which the operation panel of the target instrument is included in the area corresponding to the frame F. If such an image is generated that all the buttons, the LEDs and the like of the operation panel do not fit in the frame F because the operation panel is inclined with respect to the frame F, and so on, then there are a possibility that analysis accuracy in the analysis unit 21b to be described later decreases and a possibility that it takes long to identify the model and the light emission pattern. The whole of the operation panel is prompted to be captured in the frame F, so that reduced can be the possibility that the accuracy of the analysis processing decreases and the possibility that it takes long to process the identification.

The analysis unit 21b causes the processor 20 to achieve an analysis function to analyze the image obtained by imaging the target instrument by the camera 60 and to identify the model of the target instrument. In this embodiment, the processor 20 identifies the model group corresponding to the target instrument. The processor 20 acquires images of a plurality of frames which constitute a live view video obtained by imaging the operation panel while capturing the buttons or the LEDs on both ends of the operation panel within the frame F. The processor 20 detects an object, which indicates the button, the LED and the like based on the image of at least one frame among the plurality of frames. For example, the processor 20 extracts an object with a circular contour line, which is included in the frame image, and subsequently, detects a letter or an icon, which is included in an internal area of the contour line, by template matching. The processor 20 regards the object, in which the letter or the icon is included in the internal area of the contour line, as an object of a button of a type corresponding to the letter or the icon. Moreover, the processor 20 regards a circular object with a difference of a predetermined level or more from a color of an exterior color of the operation panel, the circular object being other than such a button object, as the LED unit. Further, the processor 20 identifies designs (for example, the icons (Di, Ds and the like, letters, logotypes and the like), which are other than the buttons and LEDs of the operation panel and are formed on the panel, by the template matching. The processor 20 identifies relative positions of these objects in the frame image. For example, with an object of a certain specific button taken as a reference, the processor 20 identifies positional relationships of the other objects.

The processor 20 identifies the model group, to which the target instrument belongs, based on the relative positions of the plurality of positions indicating the objects which indicate the buttons and the LEDs included in the image. That is, the processor 20 refers to the operation panel data 30c of each of the model groups, and identifies such a model group in which the arrangements (the relative positions) of the respective objects as the buttons, the LEDs and the like, which are included in the image, and the arrangements of the buttons and the LEDs coincide with each other. Herein, for each of the model groups, the operation panel data 30c includes information indicating shapes, colors and positional relationships of the objects as the buttons and the LEDs and other formed articles, which are arranged on the operation panel.

Upon identifying the model group of the target instrument, the processor 20 identifies the meaning of the display content of the target instrument. The translation unit 21c identifies the translation rule 30a, which corresponds to the identified model, from among a plurality of the translation rules 30a, and causes the processor 20 to achieve the translation function to translate the display content of the target instrument, which is included in the image, based on the identified translation rule 30a. Specifically, in order to analyze the light emission pattern of the LED units, the processor 20 refers to the operation panel data 30c corresponding to the identified model group, and acquires information indicating colors of the turned-on LED units. Among the LED units in the image, the processor 20 regards LED units, which apply to the turned-on color, as those in the turned-on state in the relevant image, and regards other LED units as those in the turned-off state.

The processor 20 analyzes the live view video (the moving picture), and determines the states of the respective LED units. That is, the processor 20 time-sequentially analyzes the images of the respective frames which constitute the live view video, and determines whether each of the LED units is turning on, is turning off or is blinking. The processor 20 regards such an LED unit that continues to turn on for a certain period as a turned-on LED unit, regards such an LED unit that continues to turn off for a certain period of time as a turned-off LED unit, and regards such an LED unit in which the turned-on state and the turned-off state are periodically changed for a certain period as a blinking LED unit. In this way, the processor 20 determines whether each of the LED units is turning on, is turning off or is blinking.

As mentioned above, in this embodiment, the translation rule 30a is information in which the light emission pattern of the respective LED units and the applying space of the user's guide, in which the message indicated by this light emission pattern is described, are associated with each other. For example, in the operation panel illustrated in FIG. 2, such a light emission pattern in which the L₁ and L₂ LED units are turning off and the L₃ and L₄ LED units are blinking and the space where this light emission pattern is described in the user's guide 30b are associated with each other. The processor 20 identifies the applying space of the user's guide corresponding to the light emission pattern, which is indicated by the states of the respective LED units, with reference to the translation rule 30a corresponding to the model group. More specifically, the processor 20 refers to the language information 30d, and identifies a language set in the operating system of the smart phone 10. Then, the processor 20 refers to the translation rule 30a, and identifies the space where the display content (that is, the light emission pattern of the LED units in the case of this embodiment) of the target instrument is described in the user's guide 30b of the relevant language. When the user's guide corresponding to the language is not stored in the storage medium 30, the processor 20 downloads such a user's guide, which corresponds to the model group of the target instrument and the language to be used by the user, from the Web side of the manufacturer of the target instrument, and causes the storage medium 30 to store the downloaded user's guide. The processor 20 identifies the applying space of the user's guide 30b, and acquires the described content (text, illustration and the like) of the applying space. The processor 20 acquires the described content of the message, which is indicated by the light emission pattern of the LED units, in the user's guide 30b corresponding to the model group and the language to be used by the user, and thereby translates the display content of the target instrument.

The notification unit 21d causes the processor 20 to achieve a notification function to notify the user of the translation result. That is, the processor 20 causes the display of the UI unit 40 to display the above-mentioned translation result by the translation unit 21c, that is, the described content (text, illustration and the like) of the applying space of the user's guide 30b, and thereby notifies the user of the translation result.

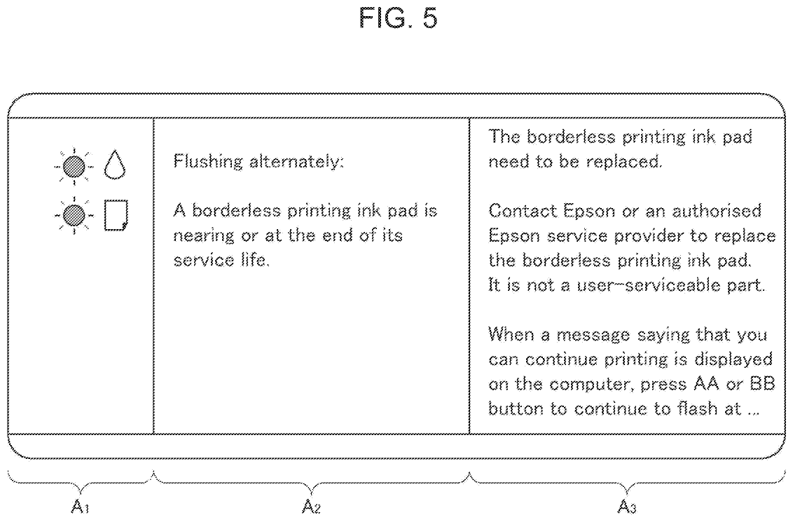

FIG. 5 is a diagram illustrating an example of the translation result displayed on the display of the smart phone 10. The example of FIG. 5 illustrates that, on the display, displayed are: an area A₁ in which illustrations indicating the states of LEDs are displayed; an area A₂ in which an explanation indicating the states of these LEDs and a message indicating the states are displayed; and an area A₃ in which sentences indicating a workaround are displayed. Note that, as a matter of course, when all the illustrations and the sentences cannot be displayed on one screen in each of the areas A₁ to A₃, such a configuration is adopted so that the user is able to browse the whole by a scroll operation of the user.

As described above, in this embodiment, the image obtained by imaging the target instrument by the camera is analyzed to identify the model group of the target instrument, the display content of the target instrument is translated according to the translation rule corresponding to the model group, and the user is notified of the translation result. Therefore, the user himself/herself does not need to identify the user's guide corresponding to the model of the target instrument, to determine the display content of the target instrument, or to find, from the user's guide, the space where the display content is described, so that the burden of the user can be reduced.

### 2. Display Content Notification Processing

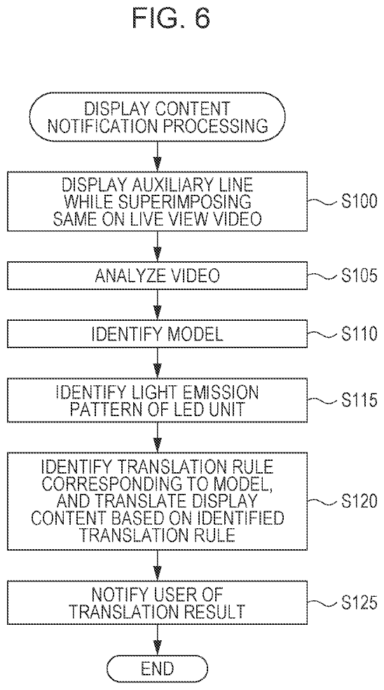

Next, display content notification processing by the display content notification program 21 is described with reference to a flowchart of FIG. 6. In a state of selecting the display content notification program 21 from an application list of the smart phone 10 and activating the application, the user activates the camera 60, so that the display content notification processing is started. Note that a configuration may be adopted so that, when the user selects and activates the display content notification program 21, the camera 60 is activated in conjunction therewith.

When the display content notification processing is started, then by the function of the imaging assistance unit 21a, the processor 20 causes display of the auxiliary line frame while superimposing the same on the live view video (Step S100). That is, the processor 20 causes the camera 60 to image a moving picture, and causes the imaged video to be displayed as a live view video on the display of the UI unit 40. Moreover, on a predetermined position of the display, such a frame F (an auxiliary line) as illustrated in FIG. 4 is displayed while being superimposed on the live view video.

Subsequently, by the function of the analysis unit 21b, the processor 20 analyzes the moving picture (Step S105). That is, the processor 20 analyzes the frame images which constitute the live view video imaged by the camera 60, and identifies the positions of the objects such as the buttons and the LED units in the frame images.

Subsequently, by the function of the analysis unit 21b, the processor 20 identifies the model (Step S110). That is, the processor 20 collates the types and positional relationships of the objects such as the buttons and the LEDs with the operation panel data 30c of the respective model groups, and identifies the coinciding the model group. Note that, when the model cannot be identified, the processing of Step S105 and S110 is repeatedly performed for objects which are sequentially acquired new frame images.

Subsequently, by the function of the translation unit 21c, the processor 20 identifies the light emission pattern of the LED units (Step S115). That is, the processor 20 sequentially analyzes the respective frame images which are imaged for a certain period by the camera 60 and constitute the live view video, identifies the color for each of the LED units included in the frame images, and determines whether each of the LED units turns or turns off in the frame images. Moreover, the processor 20 determines whether or not the color of each of the LEDs changes periodically, that is, whether or not the turning on and the turning off change periodically. When the LED unit in which the turning on and the turning off change periodically is present, the processor 20 regards this LED unit as a blinking LED unit.

Subsequently, by the function of the translation unit 21c, the processor 20 identifies the translation rule corresponding to the model, and translates the display content based on the identified translation rule (Step S120). That is, among the plurality of translation rules 30a stored in the storage medium 30, the processor 20 identifies the translation rule 30a corresponding to the model group identified in Step S110. The processor 20 refers to the translation rule 30a corresponding to the model group, and identifies the applying space of the user's guide 30b, in which the message indicated by the light emission pattern identified in Step S115 is described. Note that, at this time, the processor 20 identifies the applying space of the message indicated by the light emission pattern in the user's guide 30b corresponding to the language to be used by the user. The processor 20 acquires the text and the illustration, which are described in the identified space, and thereby translates the display content of the target instrument.

Subsequently, by the function of the notification unit 21d, the processor 20 notifies the user of the translation result (Step S125). That is, the processor 20 causes the display of the UI unit 40 to display the content of the message described in the applying space of the user's guide 30b, and thereby notifies the user of the translation result.

### 3. Other Embodiments

The above embodiment is merely an example for embodying the present disclosure, and it is also possible to adopt other various embodiments. For example, as the target instrument, besides the printer, a variety of electronic instruments may be assumed, which notify the user of the message by the display content of the LEDs and the like.

In the analysis function, it is sufficient that the image obtained by imaging the target instrument by the camera can be analyzed to make it possible to identify the model of the target instrument. “To identify the model” represents that a plurality of model groups which use at least a common translation rule are to be identified. Note that, as a matter of course, a configuration may be adopted so that the identified model is further identified to be any model among the plurality of models which use the common translation rule. The analysis function may have a configuration to identify the model by distinguishing the design indicating the model, the design being included in the image. This design may be a character string indicating a model name, a model number, and a series name.

The target instrument may be a model provided with a liquid crystal panel. The liquid crystal panel with which the target instrument is provided may be assumed to be one that can display, for example, numbers, letters and the like, but does not have a size and resolution, which are enough to display the described content (text and illustration) of the user's guide. The analysis function may be configured to identify a plurality of positions of the buttons/the LEDs/the liquid crystal, which are included in the image, and to identify the model based on relative positions of the plurality of identified positions.

Note that the analysis function may be configured to acquire, from the camera, information indicating a focal point distance at the time of imaging, to convert distances in the image between the plurality of objects such as the buttons/the LEDs/the liquid crystals into relative distances in the real space based on the focal point distances, and to identify the model based on the relative distances. Specifically, when the operation panel of the target instrument is in focus, the analysis function is capable of identifying the distance between the camera and the operation panel based on the information indicating the focal point distance. The distances in the image between the respective objects arranged on the operation panel distant from the camera by the relevant distance are convertible into the distances in the real space if reference is made to such pre-prepared correspondence relationships (the correspondence relationships between the distances in the image between the objects on the operation panel and the real distances, the correspondence relationships being prepared for each of the distances between the camera and the operation panel). In this way, it is possible to acquire the real distances between the objects. Note that, in the case of identifying the model based on the information indicating the focal point distance as described above, the operation panel data also includes the information about the distances between the respective objects on the operation panel, the analysis function is configured to identify a model in which the relative distances between the objects, which are calculated based on the focal point distances, and the distances between the objects, which are stored in the operation panel data coincide with each other.

It is sufficient that the analysis function can analyze the image imaged by the camera. The image as an analysis target may be a live view video, may be a still image converted into a still image file in a predetermined format a stored in a storage medium, or a moving picture converted into a moving picture file in a predetermined moving picture format and stored om a storage medium.

In the notification function, as in the above-described embodiment, the notification of the translation result may be configured to be performed by being displayed on the screen of the display content notification device, may be configured to be performed by outputting a voice that indicates the translation result from a speaker of the display content notification device, or may be confirmed so that both thereof are performed. Moreover, the translation result may be displayed on a screen of an external device other than the display content notification device, or a voice may be output from a speaker of the external device. In the case of the notification using a voice, for example, the translation rule includes audio data or an address for acquiring the audio data from the outside, and voices indicating turning-on and blinking states of the respective LEDs, messages indicated by those states, and workarounds for those states may be configured to be output by reproducing the audio data.

Moreover, the present disclosure is also established as a disclosure of a display content notification device including: a camera that images a target instrument; and a notification unit that notifies a user of a translation result of translating an image imaged by the camera, in which the translation result is a result of translation performed by using a translation rule corresponding to a model of the target instrument, which is identified by analysis of the image. Translation processing may be configured to be executed in the display content notification device, or may be configured to be executed in an external server that has received a request from the display content notification device. In the latter case, the notification unit of the display content notification device notifies the user of the translation result returned from the server. The display content notification device may be achieved by a PC provided with a camera, a combination of the camera and the PC, as well as a portable terminal such as a smart phone and a tablet.

Further, the present disclosure is also established as a disclosure of a display content notification method including: causing a camera to image a target instrument; and notifying a user of a translation result of translating a display content included in the imaged image, in which the translation result is a result of translation performed by using a translation rule corresponding to a model of the target instrument, which is identified by analysis of the imaged image.

Furthermore, the present disclosure is also applicable as a program or a method, which is executed by a computer. Moreover, the system, the program, and the method, which are as described above, are sometimes achieved individually as single devices, are sometimes achieved by using components with which a plurality of devices are provided, and include a variety of aspects. Further, the system, the program, and the method are appropriately changeable such that some are software and some are hardware. Furthermore, the disclosure is also established as a storage medium of a program for controlling the system. As a matter of course, the storage medium of that program may be a magnetic storage medium, or may be a semiconductor memory, or any storage media which will be developed in the future can also be regarded similar thereto entirely.

What is claimed is:

1. A non-transitory computer-readable storage medium storing a display content notification program to control a computer provided with a camera, the program comprising:
an analysis function to analyze an image obtained by imaging a target instrument by the camera, and to identify a model of the target instrument;
a translation function to identify a translation rule from among a plurality of translation rules, the translation rule corresponding to the identified model, and to translate a display content of the target instrument based on the identified translation rule, the display content being included in the image; and
a notification function to notify a user of a translation result.

2. The non-transitory computer-readable storage medium according to claim 1, wherein the analysis function identifies a plurality of positions of buttons/LEDs/liquid crystals included in the image, and identifies the model based on relative positions of the plurality of identified positions.

3. The non-transitory computer-readable storage medium according to claim 2, wherein
the analysis function acquires information about focal point distances imaged by the camera, calculates relative distances of the plurality of positions identified from the focal point distances, and identifies the model based on the relative distances.

4. The non-transitory computer-readable storage medium according to claim 1, wherein
the analysis function identifies the model by distinguishing a design of the model, the design being included in the image.

5. The non-transitory computer-readable storage medium according to claim 4, wherein
the design is a character string indicating a name of the model.

6. The non-transitory computer-readable storage medium according to claim 1, wherein
the analysis function identifies whether the identified model is any model among the plurality of models which use the common translation rule.

7. The non-transitory computer-readable storage medium according to claim 1, wherein
the image is a moving picture.

8. The non-transitory computer-readable storage medium according to claim 1, wherein
the translation function translates a display content of the target instrument into a language set in an operating system of the computer, and
the notification function displays the translation result on a display.

9. The non-transitory computer-readable storage medium according to claim 1, wherein
an imaging assistance function to cause display of an auxiliary line that is super imposed on a live view video and indicates a position into which the target instrument is captured.

10. A display content notification device comprising:
a camera that images a target instrument; and
a notification unit that notifies a user of a translation result of translating an image imaged by the camera, wherein
the translation result is a result of translation performed by using a translation rule corresponding to a model of the target instrument, the model being identified by analysis of the image.

11. A display content notification method comprising:
causing a camera to image a target instrument; and
notifying a user of a translation result of translating a display content included in the imaged image, wherein
the translation result is a result of translation performed by using a translation rule corresponding to a model of the target instrument, the model being identified by analysis of the imaged image.
